(19) United States
(12) Patent Application Publication
(10) Pub. No.: US 2013/0117864 A1
(43) Pub. Date: May 9, 2013

(54) AUTHENTICATION SYSTEM

(71) Applicants: HYOUNG-SUK JANG, GWANGMYEONG-SI (KR); HEE-CHANG CHO, SEOUL (KR); BO-GYEONG KANG, SUWON-SI (KR)

(72) Inventors: HYOUNG-SUK JANG, GWANGMYEONG-SI (KR); HEE-CHANG CHO, SEOUL (KR); BO-GYEONG KANG, SUWON-SI (KR)

(73) Assignee: SAMSUNG ELECTRONICS CO., LTD., SUWON-SI (KR)

(21) Appl. No.: 13/600,295

(22) Filed: Aug. 31, 2012

(30) Foreign Application Priority Data
Nov. 8, 2011 (KR) 10-2011-0115898

(51) Int. Cl. G06F 21/24; G06F 21/00

(52) U.S. Cl. 726/30; 726/26

(57) ABSTRACT

An authentication system includes: a host device; a storage device which is electrically connected to the host device through a first interface and which is configured to store contents; and an authentication device which is electrically connected to at least one module included in the storage device and which is configured to store copy protection information for the contents.

### CROSS-REFERENCE TO RELATED APPLICATION

This application claims priority from Korean Patent Application No. 10-2011-0115898 filed on Nov. 8, 2011 in the Korean Intellectual Property Office, and all the benefits accruing therefrom under 35 U.S.C. 119, the contents of which in its entirety are herein incorporated by reference.

### BACKGROUND

1. Field of the Invention

The present invention relates to an authentication system.

2. Description of the Related Art

Various types of storage devices are known. For example, a memory card using a flash memory as a storage means, and a universal memory bus (USB) memory which can be connected to a USB port, have been introduced. Further, a solid state drive (SSD) has been recently introduced and is increasingly being used. The size of a storage device is gradually reduced while the storage capacity increases. Storage devices are also being implemented with an interface which allows them to be attachable and detachable to and from a host device. Accordingly, the mobility of the storage device is gradually increased. For example, even in a hard disk which is currently regarded as one of the least expensive storage devices, an external hard disk has been introduced to provide mobility unlike a typical hard disk which is fixed in a personal computer.

Besides the storage device, the host device connected to the storage device to consume the contents stored in the storage device is also being miniaturized, and a portable host device is widely used. As described above, as digital contents stored in the storage device are available anytime and anywhere, a distribution method of contents is being changed to a method in which the contents are distributed in the form of digital data.

However, since the digital contents stored in the storage device are easy to copy, various techniques for preventing unauthorized copying of the contents have been introduced. Various content protection technologies may exist, but they are common in that consumption of the contents is permitted only for duly authorized consumers.

### SUMMARY

The present invention provides an authentication system with improved reliability of security.

The objects of the present invention are not limited thereto, and other objects of the present invention will be described in or be apparent from the following description of the embodiments.

According to an aspect of the present invention, there is provided an authentication system comprising: a host device; a storage device which is connected to the hose device through a first interface, and stores contents; and an authentication device which is electrically connected to at least a part of modules included in the storage device, and stores copy protection information for the contents.

According to another aspect of the present invention, there is provided an authentication system comprising: a host device; a storage device which is connected to the hose device through a first interface, and stores the contents; and an authentication device which is connected to the storage device through a second interface of a different type from the first interface, and stores copy protection information for the contents.

According to yet another aspect of the present invention, a system comprises: a memory device configured to store therein contents which have associated therewith at least one access control rule for access to the contents; an authentication device configured to store therein authentication device identification information for authenticating the authentication device, and copy protection information for enforcing the least one access control rule for access to the contents of the memory device; and a host device operatively connected to the memory device and to the authentication device, the host device including an authentication device verification module configured to authenticate the authentication device based on the authentication device identification information, the host device being further configured to access the contents of the memory device in accordance with the at least one access control rule.

### BRIEF DESCRIPTION OF THE DRAWINGS

The above and other aspects and features of the present invention will become more apparent by describing in detail exemplary embodiments thereof with reference to the attached drawings, in which:

FIG. 1 is a block diagram showing a configuration of an authentication system in accordance with an embodiment of the present invention;

FIG. 2 is a diagram for explaining an operation of an authentication device of the authentication system in accordance with the embodiment of the present invention;

FIG. 3 is a block diagram showing a configuration of an authentication system in accordance with another embodiment of the present invention; and

FIGS. 4 to 7 are block diagrams showing configurations of authentication systems in accordance with still other embodiments of the present invention.

### DETAILED DESCRIPTION OF THE EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. The same reference numbers indicate the same components throughout the specification. In the attached figures, the thickness of layers and regions is exaggerated for clarity.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

In the present application, when a first and a second element are said to be electrically connected or electrically coupled to each other, this does not exclude the existence of intermediate elements electrically connecting or electrically coupling the first and second elements to each other. On the other hand, when a first and a second element are said to be directly electrically connected or directly electrically coupled to each other, this means that the first and second elements are electrically connected or electrically coupled to each other without any intermediate elements, other than passive electrical wiring between the first and second elements or a direct wireless connection between the first and second elements.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

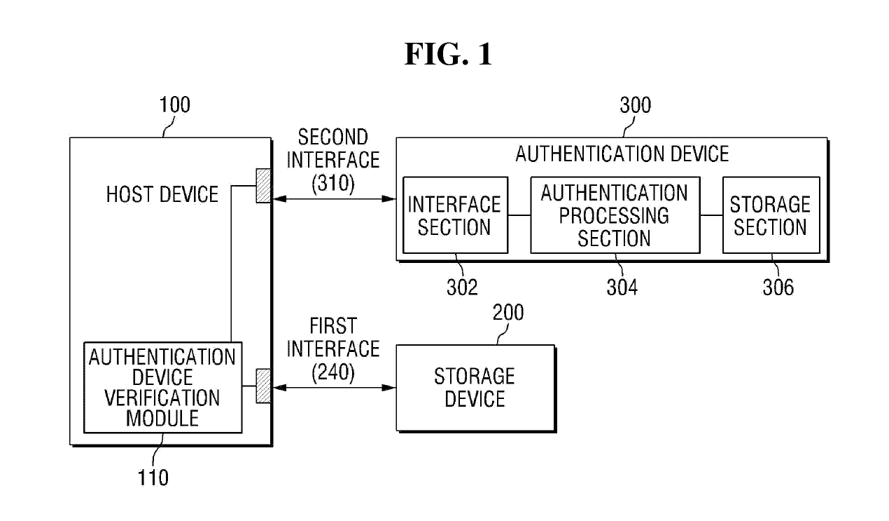

FIG. 1 is a block diagram showing a configuration of an authentication system in accordance with an embodiment of the present invention. Specifically, FIG. 1 shows a configuration of an authentication system in which an authentication device 300 is directly connected to a host device 100.

Referring to FIG. 1, the authentication system includes host device 100, a storage device 200, and authentication device 300.

Host device 100 may be a device which provides a specific command to storage device 200, and receives and consumes the contents stored in storage device 200. Here, the contents may be data digitally stored in storage device 200, e.g., music, video, document, image and computer program. Further, consuming the contents may mean displaying or printing the contents in the form of image and document, playing back the contents in the form of music and video, and installing or executing the contents in the form of application.

Host device 100 may be a device which can be connected to storage device 200 to consume the contents stored in storage device 200. As examples of host device 100, there are a mobile content consumption device such as a mobile phone, PDA, and MP3 player, and a fixed content consumption device such as a desktop computer, and digital TV.

Storage device 200 is connected to host device 100 through a first interface 240. Here, the interface may mean a physical part supporting data transmission and reception when a certain device is attached to a connector or another device. In the present invention, the interface may be a general-purpose data communication interface, e.g., serial peripheral interface (SPI), universal serial bus (USB), AT attachment (ATA), Serial ATA (SATA) or integrated drive electronics (IDE).

Meanwhile, storage device 200 may store contents which may be consumed by host device 100. Storage device 200 may be, e.g., a USB memory device, a memory card such as an SD card or MMC card, an external hard disk, an external SSD, etc.

Authentication device 300 is connected to host device 100 through a second interface 310. Authentication device 300 may store authentication device identification information and copy protection information for the contents stored in storage device 200.

Specifically, authentication device 300 may include a storage section 306, an interface section 302 which provides a connection to host device 100 using second interface 310, and an authentication processing section 304 which performs an authentication process associated with the consumption of the contents stored in storage device 200.

Storage section 306 may store the authentication device identification information and the copy protection information for the contents stored in storage device 200. Storage section 306 may be implemented as one or more non-volatile memory device, each of which may be, for example, a read only memory (ROM), a programmable ROM (PROM), an erasable programmable ROM (EPROM), an electrically erasable programmable ROM (EEPROM), a flash memory, without being limited thereto.

Authentication processing section 304 may perform an authentication process using the authentication device identification information according to an authentication request signal received through interface section 302, and output an authentication response signal containing an authentication result.

The authentication process performed by the authentication processing section 304 is carried out for consumption of the contents stored in storage device 200 and may be started upon receipt of an authentication request signal inputted from host device 100 through interface section 302.

The authentication request signal received from host device 100 contains authentication device identification information that should match the authentication device identification information included in the contents stored in storage section 306. Accordingly, the authentication process may include comparing the authentication device identification information stored in storage section 306 with the authentication device identification information included in the authentication request signal received from host device 100 to generate the authentication result.

That is, authentication processing section 304 determines successful authentication as the authentication result only if the authentication device identification information included in the authentication request signal received from host device 100 matches the authentication device identification information stored in storage section 306. In this way, when authentication processing section 304 determines whether the authentication is successful or failed, authentication processing section 304 outputs the authentication response signal containing the authentication result to host device 100.

In this embodiment, authentication device 300 is configured as at least one microchip or microprocessor designed to perform only a predetermined operation. Accordingly, it cannot be maliciously changed to perform other operations. That is, since it is impossible to manipulate the authentication result by external manipulation in software, it is possible to enhance the reliability of security.

Meanwhile, if the determination on whether the authentication is successful or failed is performed in authentication device 300, copy protection of the contents cannot be achieved in a case where there is a hacked authentication device which always determines that the authentication is successful. In order to avoid such a situation, the authentication process may include transmitting the authentication device identification information stored in storage section 306 to host device 100 through interface section 302. In this case, generation of the authentication result may be generated by an authentication device verification module 110 provided in host device 100 rather than being generated by authentication device 300.

Further, the authentication process may include encrypting the authentication device identification information and providing the encrypted information to host device 100. That is, the authentication response signal output from authentication device 300 to host device 100 may include encrypted authentication device identification information. In this case, it is possible to prevent the authentication device identification information from being exposed to a third party who makes an unauthorized copy of the contents of storage device 200.

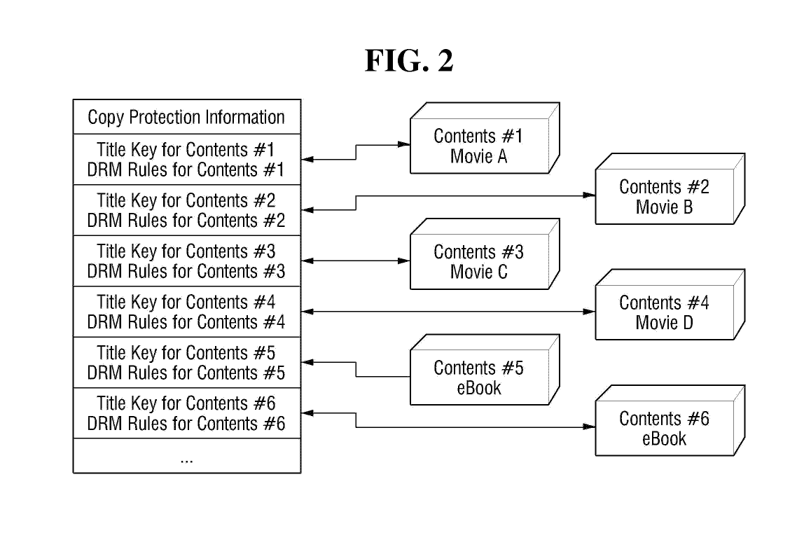

Meanwhile, the authentication processing section 304 may perform the authentication process associated with the consumption of the contents of storage device 200 based on the copy protection information for the contents stored in storage section 306. Hereinafter, this process will be described in detail with reference to FIG. 2.

FIG. 2 is a diagram for explaining an operation of the authentication device of the authentication system in accordance with the embodiment of the present invention.

Referring to FIGS. 1 and 2, the copy protection information for the contents stored in storage section 306 may include an encryption key associated with the encryption of the contents stored in storage device 200.

Here, the encryption key may be, e.g., a title key. If the contents stored in storage device 200 are encrypted by an encryption algorithm such as AES-128, each title key may have a length of 16 bytes, and a set of title keys as shown in FIG. 2 may be stored in storage section 306. Further, the contents encrypted by such title keys are stored in storage device 200.

If host device 100 requests the contents stored in storage device 200 after completion of the authentication of the authentication device identification information as described above, the authentication processing section 304 decrypts the encrypted contents stored in storage device 200 using the title keys stored in storage section 306 and provides the decrypted contents to host device 100.

As described above, since the encryption keys (e.g., title keys) required to encrypt and decrypt the contents stored in storage device 200 are stored and managed independently of storage device 200 storing the contents, it is possible to increase the reliability of security in consuming the contents.

Meanwhile, referring again to FIGS. 1 and 2, the copy protection information for the contents stored in storage section 306 may include access control rules, for example digital rights management (DRM) rules, for administering access to the contents stored in storage device 200. Host device 100 may access the contents stored in storage device 200 in accordance with those access control rules.

Here, the DRM rules may include a limitation on the number of playbacks of each of the contents, an expiration date of each of the contents, a limitation on the resolution in the playback of each of the contents, and the like.

If host device 100 requests the contents stored in storage device 200 after completion of the authentication of the authentication device identification information as described above, the authentication processing section 304 determines whether the contents stored in storage device 200 are provided to host device 100 and which level of resolution is chosen if provided according to the DRM or access control rules for administering access to those contents. It may be implemented such that the contents whose authentication has failed in authentication processing section 304 cannot be transmitted to host device 100, or authentication device verification module 110 of host device 100 is provided with only the authentication result value from the authentication processing section 304 and determines whether the contents are consumed.

For example, if host device 100 requests provision of Contents #1 (see FIG. 2), first, the authentication processing section 304 searches the DRM rules for Contents #1 stored in storage section 306.

As the search results of the DRM rules, if Contents #1 are contents which have been played back more than the limited number of time, or are contents whose access rights have expired, then authentication processing section 304 operates such that Contents #1 are prevented from being provided to host device 100.

However, if the number of times of requesting for Contents #1 is currently less than the limited number, and the current time point is earlier than the expiration date, authentication processing section 304 authorizes that Contents #1 be provided to host device 100. However, it is controlled such that Contents #1 having a limited resolution according to the DRM rules for Contents #1 stored in storage section 306 is provided to host device 100.

In summary, when the contents stored in storage device 200 are provided to host device 100, authentication processing section 304 determines whether the contents are provided to host device 100 and the resolution level of the contents provided to host device 100 according to the DRM rules.

Authentication processing section 304 may include at least one operation unit for performing authentication processes as described above, and the operation unit may be, e.g., a microprocessor or microchip.

Referring again to FIG. 1, interface section 302 manages data transmission and reception between authentication device 300 and storage device 200 through second interface 310. Interface section 302 may include a connector (not shown) which provides a detachable electrical connection to host device 100. In a case where interface section 302 provides a detachable electrical connection to host device 100, if the authentication of the contents stored in one storage device 200 has been completed, authentication device 300 may be connected to another host device 100 to enable authentication of contents stored in another storage device 200. Accordingly, the contents stored in two or more storage devices 200 may be consumed using one authentication device 300.

As illustrated, authentication device 300 is electrically connected (e.g., directly electrically connected) to host device 100 through second interface 310. That is, authentication device 300 transmits and receives data to and from host device 100 through second interface 310. Storage device 200 is electrically connected (e.g., directly electrically connected) to host device 100 through first interface 240. That is, storage device 200 transmits and receives data to and from host device 100 through first interface 240. As illustrated in FIG. 1, second interface 310 is separated from first interface 240. Second interface 310 and first interface 240 may be of the same type or configuration. For example, both second interface 310 and first interface 240 may be USB interfaces, and authentication device 300 and storage device 200 may be electrically connected to different USB ports of host device 100. Alternatively, second interface 310 and first interface 240 may be of different types or configurations.

In some embodiments, second interface 310 may be a wireless communication interface. For example, second interface 310 may be a short-range wireless communication mode such as Bluetooth, near field communication (NFC), or radio frequency identification (RFID). In this case, there is an effect of reducing the inconvenience caused by physically connecting an authentication device to a host device, while maintaining an object of preventing an unauthorized copy of contents. However, it should be construed that a long-range wireless communication interface such as Internet and 3G mobile communication interface is excluded from second interface 310. This is because an unlimited number of storage devices 200 can be authenticated using one authentication device 300 in this case.

Authentication device 300 of this embodiment may further include a verification module installation unit (not shown) for installing an authentication device verification module if authentication device verification module 110 is not installed in host device 100. Authentication device verification module 110 is a module for performing an authentication process on the side of host device 100 if a user of host device 100 inputs a command for consuming the contents stored in storage device 200.

The authentication process on the side of host device 100 may include the following operation.

First, authentication-related information included in the contents is extracted, and the authentication device identification information is obtained from the authentication-related information.

Then, the authentication request signal is transmitted to authentication device 300 to verify whether authentication device 300 storing the authentication device identification information is electrically connected (e.g., directly electrically connected) to host device 100. The authentication request signal may contain authentication device identification information that should match the authentication device identification information included in the contents of storage section 306.

Then, the data included in the authentication response signal received from authentication device 300 are analyzed. If the authentication response signal includes authentication device identification information that should match the authentication device identification information that is stored in the contents of storage section 306, then the authentication response signal may include data indicating whether the authentication is successful or failed. In this case, authentication device verification module 110 may determine whether to authorize the consumption of the contents stored in storage device 200 based on the authentication result indicating whether the authentication is successful.

On the other hand, if the authentication device identification information which is stored in authentication device 300 is included in the authentication response signal received from authentication device 300, then authentication device verification module 110 may determine whether the authentication is successful or failed using the authentication device identification information that is stored in authentication device 300.

Authentication device verification module 110 may represent an operation unit provided in host device 100 to perform the authentication process on the side of host device 100.

If authentication device verification module 110 is not provided in host device 100 connected to authentication device 300, the verification module installation unit (not shown) of authentication device 300 may transmit the authentication device verification module installation data stored in storage section 306 such that authentication device verification module 110 can be installed in host device 100. In this case, although the user does not perform a separate manipulation, if authentication device 300 is simply connected to host device 100, authentication device verification module 110 can be installed in host device 100.

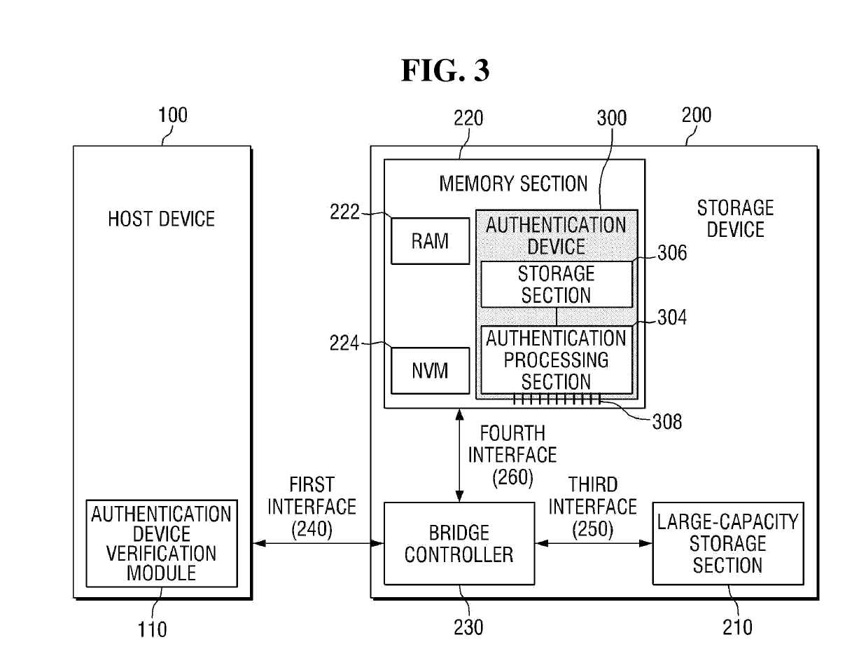

In the embodiment described above and illustrated in FIG. 2, authentication device 300 may be packaged in a separate package, housing, or structure from storage device 200, and memory device 200 and authentication device 300 may be interfaced to host device 100 through separate connectors from each other. Although an embodiment of the configuration of the authentication system, in which authentication device 300 is directly connected to host device 100 using an interface provided separately from storage device 200, has been described in the embodiment, other, different, embodiments are possible. Hereinafter, an authentication system in accordance with another embodiment will be described with reference to FIG. 3.

FIG. 3 is a block diagram showing a configuration of an authentication system in accordance with another embodiment. Specifically, FIG. 3 illustrates a first configuration example of an authentication system in which an authentication device is connected to a storage device without using a separate interface. In particular, authentication device 300 may be packaged within the same package, housing, or structure as storage device 200, and may be interfaced to host device 100 through the same connector as memory device 200.

Referring to FIG. 3, a storage device 200 includes a large-capacity (or mass) storage section 210, a memory section 220, and a bridge controller 230.

Large-capacity storage section 210 may be configured as, e.g., NAND-FLASH, NOR-FLASH, hard disk, and/or a solid state drive (SSD). Large-capacity storage section 210 may be any storage unit configured as a storage medium which can maintain data even though power is not supplied. Large-capacity storage section 210 is connected to bridge controller 230 through a third interface 250. Third interface 250 may be a data transmission and reception mode supporting data input/output of large-capacity storage section 210, e.g., AT attachment (ATA), Serial ATA (SATA) or integrated drive electronics (IDE). The contents (e.g., the access protected contents for which authorization is required) may be stored in large-capacity storage section 210.

Memory section 220 may include at least one of a non-volatile memory 224 storing firmware executed in the operation of storage device 200, and a random access memory (RAM) 222 required to execute the firmware in the operation unit of storage device 200 in the operation of storage device 200. Memory section 220 may be configured as, e.g., a NOR-FLASH module. Memory section 220 is connected to the bridge controller 230 through a fourth interface 260. Fourth interface 260 may be a data transmission and reception mode supporting data input/output of memory section 220, e.g., serial peripheral interface (SPI).

Bridge controller 230 manages data transmission and reception between host device 100 and storage device 200, and relays data transmission and reception between large-capacity storage section 210 and host device 100. That is, bridge controller 230 may perform conversion between first interface 240 serving as an external interface and third interface 250 and fourth interface 260 serving as internal interfaces.

Here, first interface 240 may be, e.g., USB, eSATA, FireWire (IEEE1394), or Bluetooth. Bridge controller 230 may perform a specific operation on the data. Further, bridge controller 230 may execute one or more algorithms according to firmware stored in memory section 220.

Authentication device 300 may be connected to storage device 200 in a manner to be electrically connected to at least one or more of the modules forming storage device 200. Authentication device 300 may include authentication processing section 304. Further, authentication processing section 304 may be electrically connected to at least one or more of the modules forming storage device 200.

In this embodiment, authentication device 300 may be provided in memory section 220 to be electrically connected to memory section 220. Authentication device 300 may include storage section 306 storing the authentication device identification information and the copy protection information, and a connector 308 which provides an electrical connection to memory section 220, and the authentication processing section 304 which performs various authentication processes as described above in response to the authentication request signal received through connector 308. Authentication processing section 304 may be a circuit which performs the authentication process using the authentication device identification information serving as unique identification information of authentication device 300, and performs the authentication process associated with the consumption of the contents of large-capacity storage section 210 based on the copy protection information for the contents. Since an operation by which authentication processing section 304 performs the authentication process based on the authentication device identification information stored in storage section 306 and the copy protection information for the contents has been fully described above, a detailed description thereof is not repeated.

As shown in FIG. 3, memory section 220 included in storage device 200 may include non-volatile memory (NVM) 224, storing the firmware that is executed in the operation of storage device 200, and RAM 222. In this embodiment, it should be construed that authentication device 300 is not a program stored in non-volatile memory 224, and authentication device 300 configured in hardware is electrically connected to the inside of memory section 220 which transmits and receives data through bridge controller 230 and fourth interface 260. For example, authentication processing section 304 may be mounted on a substrate of a module of memory section 220, and authentication device 300 may transmit and receive data to and from host device 100 through fourth interface 260, bridge controller 230 and first interface 240. Further, authentication processing section 304 may be formed on the substrate of a module of memory section 220.

Connector 308 provides an electrical connection between authentication device 300 and memory section 220. Connector 308 connects authentication device 300 with a connecting portion of memory section 220 connected to fourth interface 260 such that a signal provided to authentication device 300 can be transmitted to authentication processing section 304, and a signal generated by authentication processing section 304 can be transmitted to bridge controller 230 through fourth interface 260 and transmitted to host device 100 through first interface 240.

Authentication processing section 304 performs the above-described authentication processes if the authentication request signal for consuming the contents stored in large-capacity storage section 210 is received from authentication device verification module 110 of host device 100.

As in the above-described embodiment, in a case where authentication device 300 is directly connected to host device 100, authentication device 300 is physically independent of storage device 200. Accordingly, although a copy of contents has not been made, if it does not have authentication device 300, it may not be allowed to consume the contents in some situations. However, in a case where authentication device 300 is directly connected to storage device 200 as in this embodiment, such situations do not occur.

Further, it is possible to prevent the use of a hacked authentication device which always determines that the authentication is successful. Specifically, if authentication device 300 is connected to an internal module of storage device 200, in order to hack the system it is required to dismantle the inside of storage device 200 and replace a normal authentication device 300 connected to storage device 200 with a hacked authentication device. Since this operation is not easy, there is an effect of further preventing the use of a hacked authentication device.

Meanwhile, in this embodiment, authentication processing section 304 is a circuit designed to perform the authentication process upon receipt of the authentication request signal and output the authentication response signal containing the authentication result. In other words, the authentication process is not implemented in software, but implemented at a circuit level. Since the authentication process is conducted according to the operation of each element included in the circuit, the stability of the authentication process can be ensured unless each element included in the circuit is physically changed. Accordingly, it is actually impossible to change the authentication process without authorization through hacking in software. Further, there is no need for a space for storing a separate firmware to perform the authentication process.

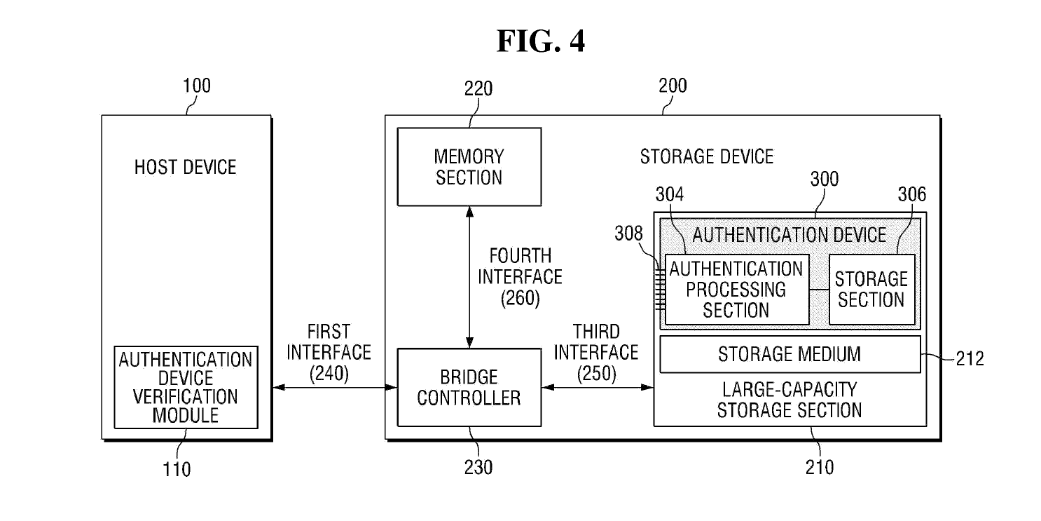

Next, an authentication system in which an authentication device is connected to a large-capacity storage section of a storage device in accordance with still another embodiment will be described with reference to FIG. 4.

FIG. 4 is a block diagram showing a configuration of an authentication system in accordance with still another embodiment. Specifically, FIG. 4 illustrates a second configuration example of the authentication system in which an authentication device is connected to a storage device without using a separate interface.

Referring to FIG. 4, authentication device 300 is provided in the large-capacity storage section 210 and is electrically connected to storage device 200. In a case where authentication device 300 is connected to large-capacity storage section 210, it should be construed that authentication device 300 is not a program stored in a storage medium 212, and authentication device 300 configured in hardware in large-capacity storage section 210 is electrically connected to large-capacity storage section 210. Authentication device 300 transmits and receives data to and from bridge controller 230 through third interface 250.

Specifically, authentication processing section 304 may be mounted on an internal substrate of large-capacity storage section 210. Authentication device 300 may transmit and receive data to and from host device 100 through third interface 250, bridge controller 230 and first interface 240. Meanwhile, a circuit forming authentication processing section 304 may be formed on an internal substrate of large-capacity storage section 210.

Since authentication processing section 304, storage section 306 and connector 308 of authentication device 300 shown in FIG. 4 have the same operation and configuration as those of authentication device 300 shown in FIG. 3, a detailed description thereof is not repeated.

Meanwhile, as a new module of storage device 200, it may be configured such that authentication device 300 is mounted on storage device 200 and authentication device 300 is connected to storage device 200 through a specific interface. The interface between authentication device 300 and storage device 200 may be an interface which is already otherwise used in storage device 200, or an interface that is not used in storage device 200. Here, the interface used in storage device 200 may mean the third interface 250 and the fourth interface 260 shown in FIGS. 3 and 4.

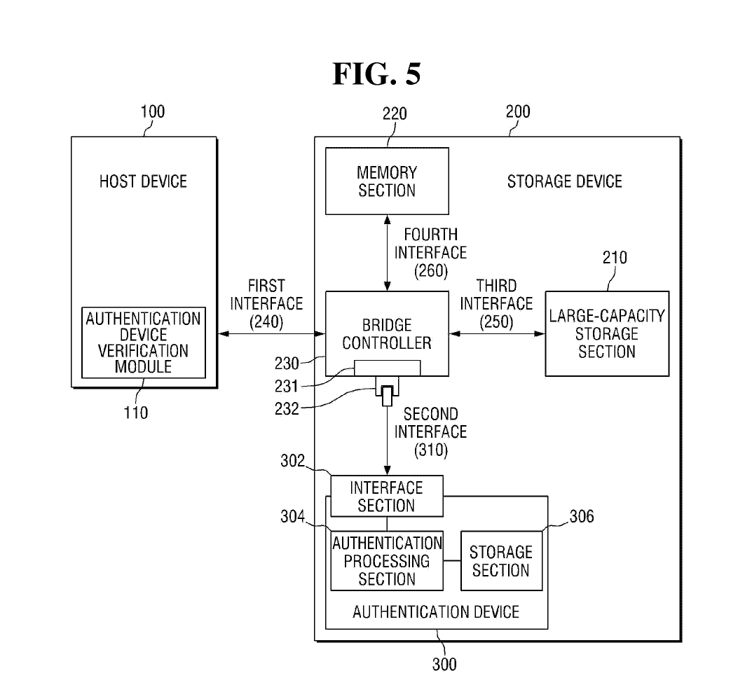

Hereinafter, an authentication system including a new module of storage device 200, in which authentication device 300 is mounted on storage device 200 and authentication device 300 is connected to storage device 200 through a specific interface, in accordance with still another embodiment will be described with reference to FIGS. 5 to 7.

FIGS. 5 to 7 are block diagrams showing configurations of authentication systems in accordance with still other embodiments.

Specifically, FIG. 5 illustrates a case where authentication device 300 is connected to bridge controller 230 using interface 310 that is otherwise not used in storage device 200.

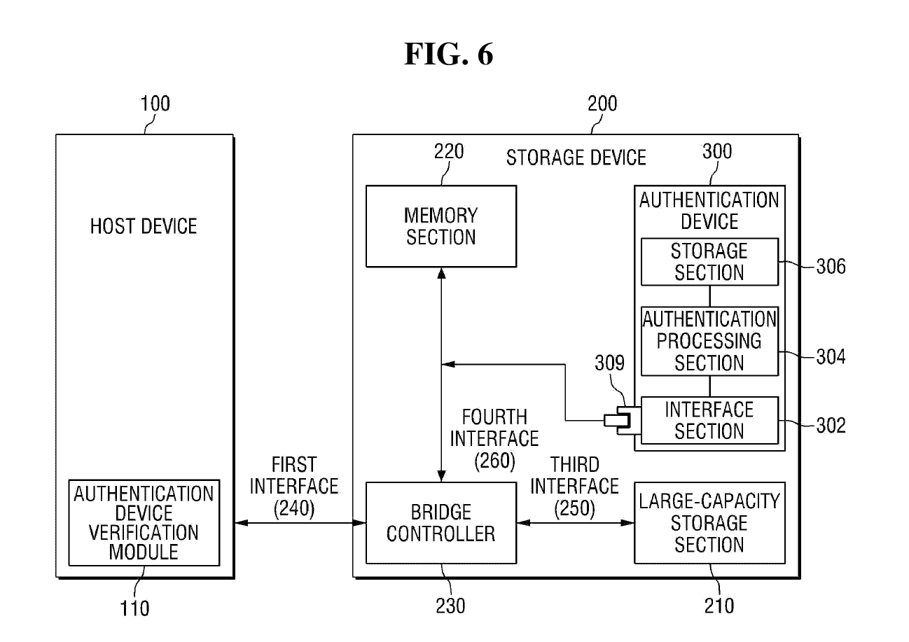

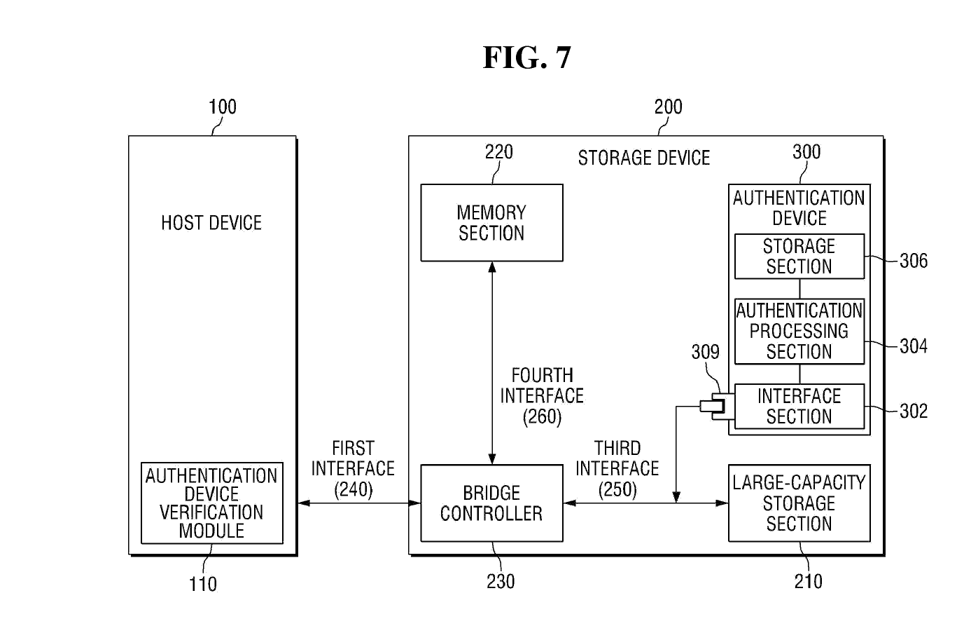

FIG. 6 illustrates a case where authentication device 300 is connected to bridge controller 230 using fourth interface 260 that is used in storage device 200. FIG. 7 illustrates a case where authentication device 300 is connected to bridge controller 230 using third interface 250 that is used in storage device 200.

Authentication device 300 may be mounted on storage device 200 when manufacturing storage device 200, or by a consumer after manufacturing storage device 200. If authentication device 300 is mounted on storage device 200 after manufacturing storage device 200, a connector for mounting authentication device 300 may be separately provided to allow the consumer to easily mount authentication device 300. A detailed description thereof will be described later.

First, an authentication system having a configuration in which authentication device 300 is connected to storage device 200 using an interface different from the interface used in storage device 200 will be described with reference to FIG. 5.

Referring to FIG. 5, authentication device 300 may include storage section 306 which stores the authentication device identification information and the copy protection information for the contents, interface section 302 which is connected to bridge controller 230 of storage device 200 through second interface 310, and authentication processing section 304 which performs the authentication process in response to the authentication request signal received through interface section 302.

Since authentication processing section 304 and storage section 306 have the same configuration and operation as those of authentication device 300 shown in FIGS. 2 to 4, a detailed description thereof is omitted.

Authentication device 300 of FIG. 5 is different from authentication device 300 having the connector 308 shown in FIGS. 3 and 4 in that interface section 302 is directly connected to bridge controller 230 using a general-purpose interface mode having an already set communication mode.

In this embodiment, authentication device 300 is connected to storage device 200 through second interface 310 which is of a different type or configuration from the interface which storage device 200 uses in the input/output of data. Since internal modules of storage device 200 connected to authentication device 300 do not support second interface 310, it is necessary to additionally mount a module supporting second interface 310 on an internal module of storage device 200 connected to authentication device 300. As shown in FIG. 5, in a case where authentication device 300 is connected to bridge controller 230, bridge controller 230 additionally includes a second interface support module 231 supporting second interface 310. Here, second interface support module 231 supports data input/output in a second interface mode. Further, second interface support module 231 may include a connector 232 allowing authentication device 300 to be detachably connected.

As described above, by mounting second interface support module 231 on the internal module of storage device 200 connected to authentication device 300, and providing connector 232 in the second interface support module, there is an effect of facilitating the installation and removal of authentication device 300. That is, even after the product is shipped, authentication device 300 can be attached and detached by the consumer who purchased storage device 200.

Meanwhile, in some other embodiments of the present invention, interface section 302 may connect storage device 200 through an interface which is of the same type or configuration as at least one of interfaces that storage device 200 otherwise already uses in the input/output of data. In this case, storage device 200 may not require a separate interface support module for adding authentication device 300.

Hereinafter, authentication systems having a configuration in which authentication device 300 is connected to storage device 200 using an interface which is of the same type or configuration as an interface already otherwise used in storage device 200 will be described with reference to FIGS. 6 and 7.

Referring to FIG. 6, interface section 302 may connect authentication device 300 with bridge controller 230 through an interface which is of the same type or configuration as fourth interface 260. In this case, authentication device 300 may further include a connector 309 supporting fourth interface 260. Here, fourth interface 260 may be, e.g., a serial peripheral interface (SPI). Connector 309 may include a fastening means allowing a cable having a mode of fourth interface 260 to be easily connected or removed from interface section 302.

Referring to FIG. 7, interface section 302 may connect authentication device 300 with bridge controller 230 using an interface which is of the same type or configuration as third interface 250. In this case, authentication device 300 may further include connector 309 supporting third interface 250. Connector 309 may include a fastening means allowing a cable having a mode of third interface 250 to be easily connected or removed from interface section 302.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. An authentication system comprising:
a host device;
a storage device which is electrically connected to the host device through a first interface, and which is configured to store contents; and
an authentication device which is electrically connected to at least one module included in the storage device, and which is configured to store copy protection information for the contents.

2. The authentication system of claim 1, wherein the copy protection information includes an encryption key associated with encryption of the contents.

3. The authentication system of claim 2, wherein the storage device stores encrypted contents which have been encrypted by the encryption key, and wherein the authentication device decrypts the encrypted contents using the encryption key when the encrypted contents are provided to the host device.

4. The authentication system of claim 1, wherein the copy protection information includes digital rights management (DRM) rules for accessing the contents.

5. The authentication system of claim 4, wherein the authentication device determines whether the contents are provided to the host device according to the DRM rules when the contents are provided to the host device.

6. The authentication system of claim 4, wherein the authentication device determines a resolution of the contents being provided to the host device according to the DRM rules when the contents are provided to the host device.

7. The authentication system of claim 1, wherein the storage device comprises:
a bridge controller which manages data transmission and reception between the host device and the storage device through the first interface;
a memory section connected to the bridge controller, and which includes a non-volatile memory storing firmware, and a random access memory (RAM) for executing an algorithm of the firmware; and
a mass storage section which is connected to the bridge controller and which stores the contents,
wherein the authentication device is provided in the memory section so as to be electrically connected to the memory section.

8. The authentication system of claim 1, wherein the storage device comprises:
a bridge controller which manages data transmission and reception between the host device and the storage device through the first interface;
a memory section connected to the bridge controller, and which includes a non-volatile memory storing firmware and a random access memory (RAM) for executing an algorithm of the firmware; and
a mass storage section which is connected to the bridge controller and which stores the contents,
wherein the authentication device is provided in the mass storage section so as to be electrically connected to the mass storage section.

9. The authentication system of claim 1, wherein the storage device comprises:
a bridge controller which manages data transmission and reception between the host device and the storage device through the first interface;
a memory section connected to the bridge controller through a fourth interface, and which includes a non-volatile memory storing firmware and a random access memory (RAM) for executing an algorithm of the firmware, and is; and
a mass storage section which is connected to the bridge controller through a third interface and which stores the contents,
wherein the bridge controller is electrically connected to the authentication device through a second interface.

10. The authentication system of claim 9, wherein the second interface is has a different configuration from the first interface, the third interface, and the fourth interface.

11. The authentication system of claim 10, wherein the bridge controller includes a second interface support module for supporting the second interface, and wherein the second interface support module includes a connector allowing attachment and detachment of the authentication device from the storage device.

12. The authentication system of claim 9, wherein the second interface is of the same configuration as the third interface, and wherein the authentication device includes a connector supporting the third interface.

13. The authentication system of claim 9, wherein the second interface is of the same configuration as the fourth interface, and the authentication device includes a connector supporting the fourth interface.

14. An authentication system comprising:
a host device;
a storage device which is connected to the host device through a first interface, and which is configured to store contents; and
an authentication device which is connected to the storage device through a second interface of a different configuration from the first interface, and which is configured to store copy protection information for the contents.

15. The authentication system of claim 14, wherein the authentication device comprises:
a storage section which stores the copy protection information for the contents;
an interface section which is connected to at least one module of the storage device through the second interface; and
an authentication processing section which performs an authentication process for consumption of the contents using the copy protection information.

16. A system, comprising:
a memory device configured to store therein contents which have associated therewith at least one access control rule for access to the contents;
an authentication device configured to store therein authentication device identification information for authenticating the authentication device, and copy protection information for enforcing the least one access control rule for access to the contents of the memory device; and
a host device operatively connected to the memory device and to the authentication device, the host device including an authentication device verification module configured to authenticate the authentication device based on the authentication device identification information, the host device being further configured to access the contents of the memory device in accordance with the at least one access control rule.

17. The system of claim 16, wherein the authentication device verification module is configured to authenticate the authentication device by transmitting an authentication request signal to the authentication device and receiving back from the authentication device an authentication response signal which indicates whether the authentication request signal included a correct copy of the authentication device identification information.

18. The system of claim 16, wherein the authentication device verification module is configured to authenticate the authentication device by receiving the authentication device identification information from the authentication module.

19. The system of claim 16, wherein the authentication device is packaged in a separate package from the memory device and interfaces to the host device via a separate connector than the memory device.

20. The system of claim 16, wherein the authentication device is packaged in a same package as the memory device and interfaces to the host device via a same connector as the memory device.
